(19) United States
(12) Patent Application Publication
(10) Pub. No.: US 2007/0012882 A1
(43) Pub. Date: Jan. 18, 2007

(54) Flat detector additional unit

(76) Inventor: Mathias Hornig, Erlangen (DE)

Correspondence Address: HARNESS, DICKEY & PIERCE, P.L.C., P.O.BOX 8910, RESTON, VA, 20195, US

(21) Appl. No.: 11/481,183

(22) Filed: Jul. 6, 2006

(30) Foreign Application Priority Data
Jul. 7, 2005 (DE) 10 2005 031 900.9

(51) Int. Cl. G01T 1/24

(52) U.S. Cl. 250/370.09

(57) ABSTRACT

To reduce the outlay on integrating flat detector additional units external to the detector in x-ray systems, an additional unit that can be assigned to at least one flat detector and can be arranged externally in relation to the latter is disclosed. The unit includes at least one first module having a data interface with the flat detector, at least one second module having a data interface with an imaging system, and at least one further module having a processing unit by which the data signals of the flat detector can be converted into data signals for the imaging system.

### PRIORITY STATEMENT

The present application hereby claims priority under 35 U.S.C. §119 on German patent application number DE 10 2005 031 900.9 filed Jul. 7, 2005, the entire contents of which is hereby incorporated herein by reference.

### FIELD

The invention generally relates to an additional unit, for example to one that can be assigned to at least two flat detectors and/or can be arranged externally in relation to the latter.

### BACKGROUND

Digital flat detectors based on active readout matrices, for example, made from amorphous silicon (a-Si), are known for x-ray imaging. Image information is converted in an x-ray converter, stored in photodiodes of the readout matrix as electric charge and subsequently read out via an active switching element with the aid of dedicated electronics and subjected to analog-to-digital conversion. Also known are flat detectors that can be used in a mobile fashion and be assigned to different x-ray systems, and which can be flexibly positioned relative to the respective x-ray system. Mobile flat detectors transmit data signals of x-ray images, for example by way of a connecting cable or without a cable via radio to the x-ray system or the imaging system.

Known in addition for the purpose of reducing the overall height and the power loss is a flat detector that has an external additional unit, components of the flat detector being exported therefrom and arranged in the additional unit. These components include, inter alia, a correction unit for correcting offsets, gains and defects, a voltage converter, a data interface for connection to an imaging system for the purpose of processing the data signals of x-ray images, and heat producing subassemblies.

### SUMMARY

An object of at least one embodiment of the present invention to reduce the outlay for integrating such flat detector additional units in x-ray systems.

In at least one embodiment, an additional unit can be assigned to at least two flat detectors and can be exchangeably arranged externally in relation thereto.

Owing to the modular design, the apparatus according to at least one embodiment of the invention can accommodate a variably prescribable number, in particular one that can be selected by the user, of flat detector components and interfaces in the form of modules. Consequently, the additional unit according to at least one embodiment of the invention is on the one hand suitable for use with different flat detectors sequentially, or even simultaneously, by way of at least two data interfaces each having a flat detector, and on the other hand is suitable for use with different imaging systems by way of at least one data interface with the imaging system. A single apparatus according to at least one embodiment of the invention fulfills the function for which the prior art requires a number of different apparatuses, and so costs, outlay and—in the appropriate x-ray system—space can be saved. Moreover, the processing unit can be used to convert the data signals of the flat detector into data signals for the imaging system.

According to one design of at least one embodiment of the invention, the modules are designed as plug-in cards and can be exchanged. Thus, modules can be installed, removed and exchanged in a simple, flexible and uncomplicated way.

In an advantageous way, the flat x-ray detector additional unit respectively has a data interface with a flat x-ray detector as two first modules, or respectively has a data interface with an imaging system as two second modules. The modules are expediently arranged in a housing, preferably a standardized housing, in order to transport the additional unit easily.

According to further designs of at least one embodiment of the invention, further modules have a power supply and/or a correction unit for correcting raw x-ray images and/or a voltage converter and/or additional interfaces.

### BRIEF DESCRIPTION OF THE DRAWINGS

Embodiments of the invention and further advantageous refinements in accordance with other features are explained in more detail below with the aid of example embodiments schematically illustrated in the drawings, without thereby limiting the invention to these example embodiments. In the drawings:

FIG. 1 shows a block diagram of two flat detectors and their additional units required for communication with a number of imaging systems, according to the prior art;

FIG. 2 shows a section of an inventive additional unit of modular design; and

FIG. 3 shows a block diagram of three flat detectors and their inventive additional unit required for communication with a number of imaging systems.

### DETAILED DESCRIPTION OF THE EXAMPLE EMBODIMENTS

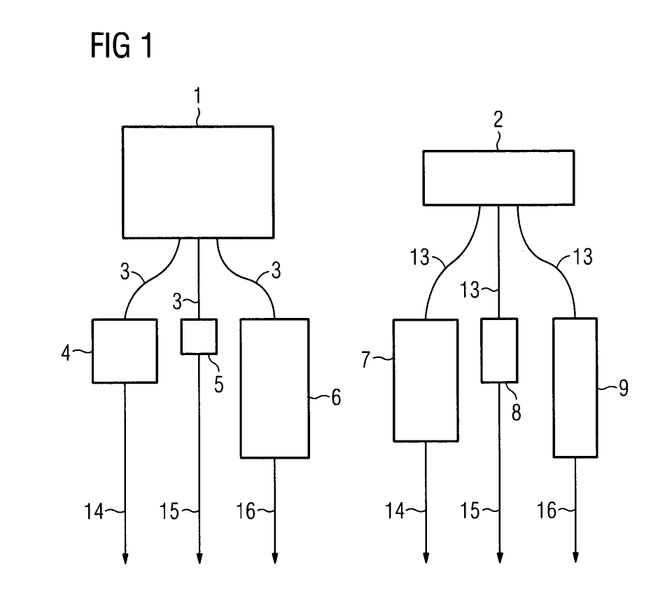

FIG. 1 shows a first flat detector 1 and a second flat detector 2 and additional units 4 to 6 and 7 to 9 according to the prior art. First to third additional units 4 to 6, which can be assigned to the first flat detector 1 via first cable connections 3, cannot be assigned to the second flat detector 2, and fourth to sixth additional units 7 to 9, which can be assigned to the second flat detector 2 via second cable connections 13, do not fit the first flat detector 1.

In order to produce a first connection 14 to a first imaging system, for example a Siemens systems, the first flat detector 1 is connected to the first additional unit 4; in order, alternatively, to produce a second connection 15 to a second imaging system, for example a Philips system, the first flat detector l is equipped with the second additional unit 5; and in order, alternatively, to produce a third connection 16 to a third imaging system, for example a Thales system, the first flat detector 1 is equipped with the third additional unit 6. For the second flat detector 2, fourth to sixth additional units 7 to 9 are required for the same connections 14 to 16 to the imaging systems.

In general, the additional units 4 to 9 are of different size, and so, for example, exchanging a first additional unit 4 for a second additional unit 5 requires a high outlay. This can be the case when the additional units are, for example, mounted in a control cubicle.

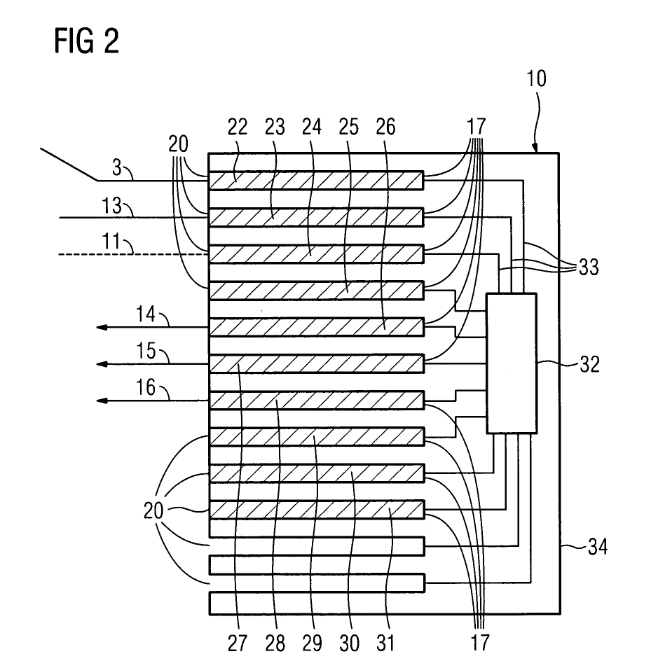

FIG. 2 shows an inventive additional unit 10 of modular design that has at least three, but preferably many more slots 20 for various modules. The modules are designed as plug-in cards 17 and can be plugged into or removed from the slots 20 such that plug-in cards 17 can be easily exchanged if required. The additional unit 10 has as module a first input interface 22 that is coupled to a first flat detector 1 by means of a first cable connection 3, a second input interface 23 with a second cable connection 13 to a second flat detector 2, and a third input interface 24 for a radio link 11 to a further flat detector 12 without a cable.

In the example embodiment illustrated, the input interfaces 22 to 24 are designed not only as data interfaces, but also as power interfaces, and likewise the cable connections 3; 13 and the radio link 11 are suitable both for a data transmission and for a power transmission. The input interfaces are, moreover, provided not only for receiving, but also for transmitting data signals and power.

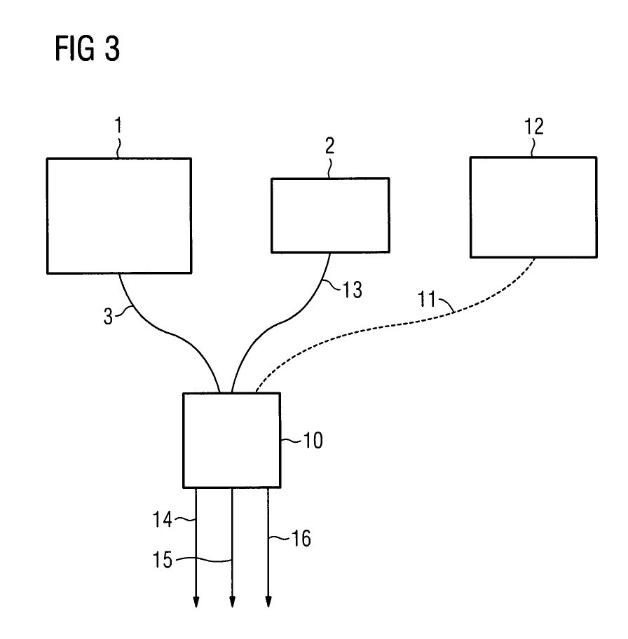

If required, the input interfaces 22 to 24 can be removed, or further input interfaces can be installed in free slots 17. The additional unit 10 can be assigned simultaneously or successively to three different flat detectors 1; 2; 12 by means of the input interfaces 22 to 24, as is also shown with the aid of FIG. 3. As further modules in the form of plug-in cards 17, the additional unit 10 has a correction unit 25, a voltage converter 31 and a first output interface 26, a second output interface 27, a third output interface 28 and a connection 29 for a docking station.

The first output interface 26 is provided for a first connection 14 to a first imaging system, for example a Siemens system, while the second output interface 27 is provided for a second connection 15 to a second imaging system, for example a Philips system, and the third output interface 28 is provided for a third connection 16 to a third imaging system, for example a Thales system. The output interfaces 26 to 28 are designed both as data interfaces and as power interfaces, and in addition to transmitting can also be provided for receiving data signals and power.

Moreover, the additional unit 10 has a processing unit 30 as a further module. The processing unit 30 converts the data signals of the flat detectors 1; 2; 12 into data signals for the respective imaging systems. The modules can be interconnected by unilateral or bilateral data and/or power lines. The additional unit 10 shown in FIG. 2 as an example embodiment has a distributor unit 32 that is connected to all the modules by way of data and/or power lines 33.

Data signals of x-ray images that are received via one of the input interfaces 22 to 24 are passed on by the distributor unit 32, for example to the correction unit 25 for correction, or to the processing unit 30 for conversion into data signals for the imaging systems. Starting from the latter, the converted data signals are passed on to one of the output interfaces 26 to 28 and then transferred to the imaging systems. A power supply unit can also advantageously be provided as module for a simple power supply. According to a further refinement of at least one embodiment of the invention, the power supply unit can have a supply connection to one or more flat detectors 1; 2; 12; the latter can thereby easily be supplied with power.

Unused plug-in cards 17 can easily be removed, and the corresponding, unused slots 20 covered. The additional unit 10 according to at least one embodiment of the invention has the advantages that a number of flat detectors 1; 2; 12 can be operated simultaneously or sequentially with the aid of a single additional unit 10, and that space and costs can thereby be saved. In the case of new developments of individual components, it is possible, for example, for a correction unit 25 arranged as module in the additional unit 10 to be easily replaced by a new model in modular form.

According to a further design of at least one embodiment of the invention, the additional unit has a logic switch element, and the switch element automatically distinguishes between the incoming data signals of various flat detectors. It is thereby ensured that the data signals of a flat detector that are provided for specific processing and/or passing on are also fed to their actual intended purpose.

At least one embodiment of the invention can be briefly summarized as follows: in order to reduce the outlay when integrating in x-ray systems flat detector additional units external to the detector, an additional unit 10 that can be assigned to at least one flat detector 1; 2; 12 and can be arranged externally in relation thereto, is provided with a prescribable number of modules, at least one first module having a data interface 22; 23; 24 with the flat detector 1; 2; 12, at least one second module having a data interface 26; 27; 28 with an imaging system, and at least one further module having a processing unit 30 by means of which the data signals of the flat detector 1; 2; 12 can be converted into data signals for the imaging system.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A unit, exchangeably assignable to at least two flat detectors and externally arrangeable in relation to the at least two flat detectors, comprising:
at least two first modules, each respectively including a data interface with a respective one of the flat detectors;
at least one second module including a data interface with an imaging system; and
at least one third module including a processing unit by which the data signals of the flat detector is convertible into data signals for the imaging system.

2. The unit as claimed in claim 1, wherein the modules are designed as plug-in cards and are exchangeable.

3. The unit as claimed in claim 1, further comprising at least one further module including at least one of a power supply unit, a correction unit for correcting raw x-ray images, and a voltage converter.

4. The unit as claimed in claim 3, wherein the power supply unit includes a supply connection to a flat detector.

5. The unit as claimed in claim 1, wherein two second modules respectively include a data interface with an imaging system.

6. The unit as claimed in claim 1, wherein the modules are arranged in a housing.

7. The unit as claimed in claim 5, further comprising a logic switch element to automatically distinguish between the incoming data signals of various flat detectors.

8. The unit as claimed in claim 1, wherein the data interfaces include cable connections.

9. The unit as claimed in claim 1, wherein the data interfaces include links without cables.

10. A flat detector comprising the unit as claimed in claim 1.

11. The unit as claimed in claim 1, wherein the data interfaces include radio links.

12. A flat detector comprising the unit as claimed in claim 2.

13. A flat detector comprising the unit as claimed in claim 3.

14. A flat detector comprising the unit as claimed in claim 4.

15. A flat detector comprising the unit as claimed in claim 5.

16. A flat detector comprising the unit as claimed in claim 6.

17. A flat detector comprising the unit as claimed in claim 7.

18. A flat detector comprising the unit as claimed in claim 8.

19. A flat detector comprising the unit as claimed in claim 9.
